(19) United States
(12) Patent Application Publication
(10) Pub. No.: US 2015/0116784 A1
(43) Pub. Date: Apr. 30, 2015

(54) IMAGE FORMATION APPARATUS

(71) Applicants: KABUSHIKI KAISHA TOSHIBA, Tokyo (JP); TOSHIBA TEC KABUSHIKI KAISHA, Tokyo (JP)

(72) Inventor: Hiroshi NAKAYAMA, Mishima Shizuoka (JP)

(21) Appl. No.: 14/479,085

(22) Filed: Sep. 5, 2014

(30) Foreign Application Priority Data
Oct. 29, 2013 (JP) 2013-224493

(51) Int. Cl. H04N 1/00; G10L 13/04; H04N 1/32

(52) U.S. Cl. CPC H04N 1/00331; H04N 1/32144; G10L 13/043; H04N 2201/0094; H04N 2201/3271; H04N 2201/0081; H04N 2201/3226; H04N 2201/3266; H04N 2201/3269
USPC 358/3.28

(57) ABSTRACT

According to one embodiment, an image formation apparatus has an input processing unit, a speech recognition code generation unit, and an image formation processing unit. The input processing unit inputs a document file including text data. The speech recognition code generation unit generates speech recognition codes in units of page from the text data in the document file. The image formation processing unit controls an image formation processing of forming images in which the text data is associated with the speech recognition codes in units of page on sheets.

### CROSS-REFERENCE TO RELATED APPLICATION

This application is based upon and claims the benefit of priority from the prior Japanese Patent Application No. 2013-224493, filed on Oct. 29, 2013, the entire contents of which are incorporated herein by reference.

### FIELD

An embodiment descried herein generally relates to an image formation apparatus.

### BACKGROUND

There is conventionally known a reading apparatus dedicated to generating speech data capable of generating speech data. The read-only apparatus optically reads a printed material thereby to detect a speech recognition code on a sheet of the printed material. The read-only apparatus decodes the speech recognition code into text data, and then generates speech data based on the decoded text data.

Thus, a speech recognition code needs to be printed on a sheet of a printed material in order for the read-only apparatus to generate speech data. In other words, a speech recognition code also needs to be created while script text data of a printed material is being created. However, a new document with a speech recognition code cannot be freely created by use of an existing text file or printed material.

### BRIEF DESCRIPTION OF THE DRAWINGS

FIG. 1 is a front view illustrating an image formation apparatus according to a first embodiment.

FIG. 2 is a diagram illustrating an exemplary hardware structure of the image formation apparatus according to the first embodiment.

FIG. 3 is a functional block diagram of the image formation apparatus according to the first embodiment.

FIG. 4 is a diagram illustrating a document image with a speech recognition code formed by the image formation apparatus according to the first embodiment.

FIG. 5 is a flowchart illustrating a specific example of a control processing of forming an image with a speech recognition code on a sheet based on an externally input document file by the image formation apparatus according to the first embodiment.

FIG. 6 is a flowchart illustrating a specific example of the control processing of forming an image with a speech recognition code by reading image information on a printed material by the image formation apparatus according to the first embodiment.

FIG. 7 is a diagram illustrating a specific example of a document whose print layout is reconstructed by the image formation apparatus when the image formation apparatus according to the first embodiment creates a document with a speech recognition code from an existing printed material.

FIG. 8 is a diagram illustrating an exemplary structure of a speech recognition code reading apparatus capable of reading an image with a speech recognition code formed on a sheet by the image formation apparatus according to the first embodiment.

FIG. 9 is a flowchart illustrating a specific example of the control processing of generating speech data by the reading apparatus based on a document with a speech recognition code generated by the image formation apparatus according to the first embodiment.

FIG. 10 is a diagram illustrating a variant of a document image with a speech recognition code generated by the image formation apparatus according to the first embodiment.

### DETAILED DESCRIPTION

According to one embodiment, an image formation apparatus has an input processing unit, a speech recognition code generation unit and an image formation processing unit. The input processing unit inputs a document file including text data. The speech recognition code generation unit generates speech recognition codes in units of page from the text data included in the document file input by the input processing unit. The image formation processing unit controls an image forming operation of forming images in which the text data is associated with the speech recognition codes in units of page on sheets.

A further embodiment will be described below with reference to the drawings. In the drawings, the same reference numerals denote the same or like parts.

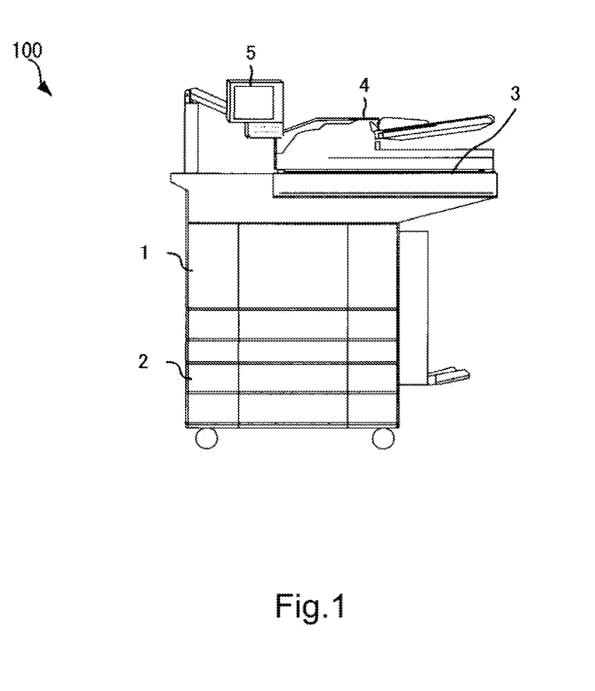

The first embodiment will be described with reference to FIG. 1. FIG. 1 is a front view illustrating an image formation apparatus 100 according to the first embodiment. The image formation apparatus 100 is quadruple tandem MFP (Multi Functional Peripheral) capable of printing color images, for example. The MFP has a copy function of scanning and reading a script image at user-designated resolution and sheet size and printing the read script image on sheets. The MFP has an image reception function by FAX, an image reception function by E-mail, an image reception function of printing via a network, and the like in addition to the copy function, for example. The MFP is a digital all-in-one machine capable of generally using various functions of a piece of office equipment described above. As illustrated in FIG. 1, the image formation apparatus 100 has an image formation device 1, a sheet supply device 2, and a reading device 3. The image formation apparatus 100 is input with a document file descried later via a network and acquires image data (input image data) based on the document file. The reading device 3 reads a script image so that the image formation apparatus 100 further acquires image data (read image data). The image formation device 1 forms an image on a sheet based on the input image data or read image data. The image formation device 1 includes an image formation unit 16 described later. The sheet supply device 2 supplies sheets (output medium) with any size used for image formation to the image formation device 1. The reading device 3 is a scanner, for example. The reading device 3 scans an object to be read (which will be called script below). The reading device 3 scans and reads image information on the script. The reading device 3 generates image data according to the read image information. The reading device 3 outputs the image data to the image formation device 1. The reading device 3 includes a scanner apparatus 18 described later. The image formation apparatus 100 further has an automatic script feeding apparatus 4 and an I/O unit 5. The automatic script feeding apparatus 4 is provided above the image formation device 1. The automatic script feeding apparatus 4 carries a sheet-shaped script to a script reading position of the reading device 3. The automatic script feeding apparatus 4 feeds the script completely scanned by the reading device 3 to a predetermined sheet feeding position. The automatic script feeding apparatus 4 continuously carries a plurality of sheet-shaped scripts to the script reading position of the reading device 3, and continuously feeds the completely scanned scripts to the sheet feeding position. The I/O unit 5 receives user inputs such as starting the image forming operation by the image formation device 1 or starting the reading operation by the image reading device 3. The I/O unit 5 has a display, for example, and receives user inputs via the display. The I/O unit 5 includes a control panel 15 described later.

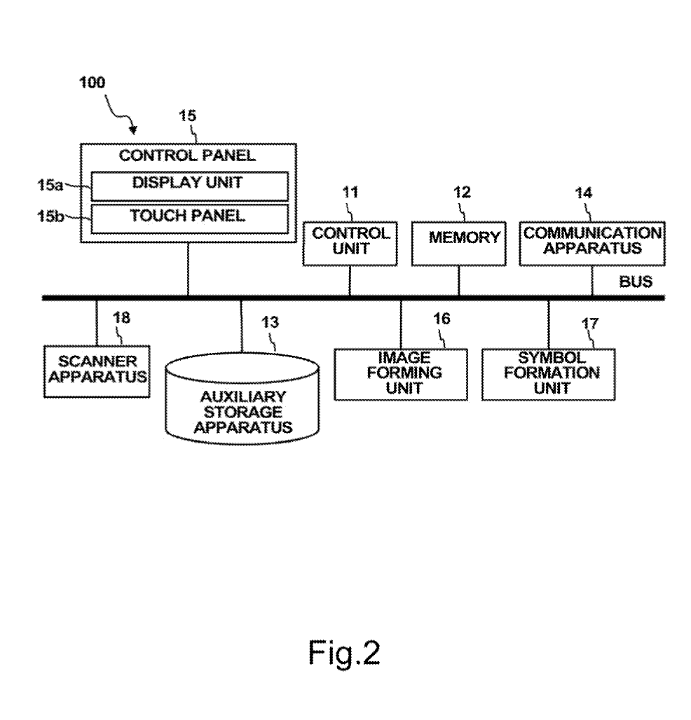

A hardware structure of the image formation apparatus 100 will be described below with reference to FIG. 2. FIG. 2 is a diagram illustrating an exemplary hardware structure of the image formation apparatus 100. As illustrated in FIG. 2, the image formation apparatus 100 has a control unit 11, a memory 12, an auxiliary storage apparatus 13, a communication apparatus 14, the control panel 15, the image formation unit 16, a symbol formation unit 17 and the scanner apparatus 18. The control unit 11 is a processor including CPU (Central Processing Unit) and the like. The control unit 11 governs and controls the operations of the image formation apparatus 100. The memory 12 is a ROM (Read Only Memory) and a RAM (Random Access Memory). The ROM stores basic programs or environment files for operating the computer therein. The RAM stores therein programs executed by the processor 11 and data necessary for executing each program. The auxiliary storage apparatus 13 is a storage apparatus such as HDD (Hard Disk Drive). The auxiliary storage apparatus 13 stores therein data on use of the image formation apparatus 100 and programs operating inside the image formation apparatus 100. The communication apparatus 14 exchanges information with a personal computer or the like connected thereto via a network such as LAN. The control panel 15 has a display unit 15a and a touch panel 15b. The display unit 15a displays an operation menu and the like. The touch panel 15b is input with user's menu selection together with the display unit 15a.

The image formation unit 16 performs an image formation processing in an electrophotographic system. Specifically, the image formation unit 16 forms an image on a sheet by an image forming process including charging, exposing, developing and fixing. The image formed on a sheet includes a speech recognition code described later. The image formation unit 16 has a plurality of units for charging, exposing, developing, fixing and the like. The symbol formation unit 17 is arranged in the sheet carrying direction on the downstream of the image formation unit 16 inside the image formation apparatus 100. The symbol formation unit 17 adds a symbol to the sheet in which the image is formed by the image formation unit 16. Specifically, the symbol formation unit 17 forms a symbol near the speech recognition code included in the image on the sheet forming the image thereon. The symbol is a concave or convex symbol discriminable from other regions on the sheet by finger touch of a visually impaired person. The symbol formation unit 17 is a dedicated braille formation apparatus, for example. The symbol formation unit 17 is a sheet post-processing apparatus for stapling or punching, for example. The scanner apparatus 18 optically scans the script as a printed material thereby to read the image information on the script. The scanner apparatus 18 generates image data (such as bitmap form image data) according to the read image information.

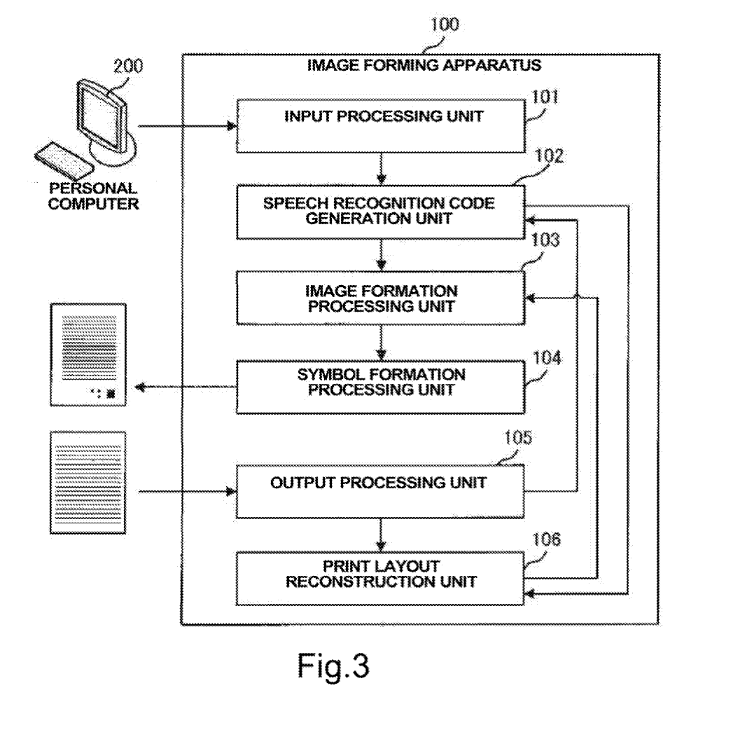

The control function of the control unit 11 in the image formation apparatus 100 will be described below with reference to FIG. 3. FIG. 3 is a functional block diagram of the control unit 11 in the image formation apparatus 100. As illustrated in FIG. 3, the control unit 11 in the image formation apparatus 100 has an input processing unit 101, a speech recognition code generation unit 102, an image formation processing unit 103, a symbol formation processing unit 104, an output processing unit 105, and a print layout reconstruction unit 106.

The input processing unit 101 inputs a document file including text data created by, for example, a personal computer 200 connected to the image formation apparatus as illustrated in FIG. 3. Specifically, the communication apparatus 14 acquires a document file from the personal computer 200 via a network. The input processing unit 101 is input with the document file from the communication apparatus 14. The input processing unit 101 outputs the document file from the communication apparatus 14 to the speech recognition code generation unit 102 as illustrated in FIG. 3. The text data is data on character strings or document made of only character codes. The document file input by the input processing unit 101 is not limited to a text file including only text data but is various files including attribute data such as font and line space, and graphic data in addition to text data.

The speech recognition code generation unit 102 generates speech recognition codes. Specifically, the speech recognition code generation unit 102 converts the text data included in the document file input by the input processing unit 101 into speech recognition codes in units of page. The speech recognition code generation unit 102 converts the text data output by the output processing unit 105 described later into speech recognition codes in unis of page. As illustrated in FIG. 3, the speech recognition code generation unit 102 outputs the generated speech recognition codes to the image formation processing unit 103 together with the document file input by the input processing unit 101. Further, the speech recognition code generation unit 102 outputs the generated speech recognition codes to the image formation processing unit 103 together with the image data output by the output processing unit 105 described later. The image formation processing unit 103 controls the image forming operation by the image formation unit 16 according to a control program. When the speech recognition code generation unit 102 generates speech recognition codes based on the text data of the document file input by the input processing unit 101, the image formation unit 16 forms images in which the text data input by the input processing unit 101 is associated with the speech recognition codes in units of page on sheets. The image formation processing unit 103 performs the image processing such that the images in which the text data is associated with the speech recognition codes are formed on sheets by the image formation unit 16. Specifically, for example, the image formation processing unit 103 associates the text data with the speech recognition codes in units of page and converts them into image data (bitmap form image data) for image formation. When data for image formation (such as graphic data) other than the text data is included in the document file input by the input processing unit 101, the image formation processing unit 103 converts the data for image formation into image data for image formation. The image formation unit 16 forms the images on sheets based on the image data. Further, when the speech recognition code generation unit 102 generates speech recognition codes based on the text data output by the output processing unit 105 described later, the image formation unit 16 forms images in which the text data output by the output processing unit 105 is associated with the speech recognition codes in units of page on sheets. Specifically, as described above, the scanner apparatus 18 reads the image information on a printed material and generates image data according to the image information. The output processing unit 105 described later converts the characters included in the image data into text data. The speech recognition code generation unit 102 generates speech recognition codes based on the text data. The image formation processing unit 103 performs the image processing for the image forming operation by the image formation unit 16 based on layout information described later. Specifically, for example, the image formation processing unit 103 converts the speech recognition codes into image data (bitmap form image data). The image formation processing unit 103 combines the image data of the speech recognition codes with the image data generated by the scanner apparatus 18 based on the layout information described later. The image formation processing unit 103 generates image data for image formation by the combination. The image formation unit 16 forms images on sheets based on the image data.

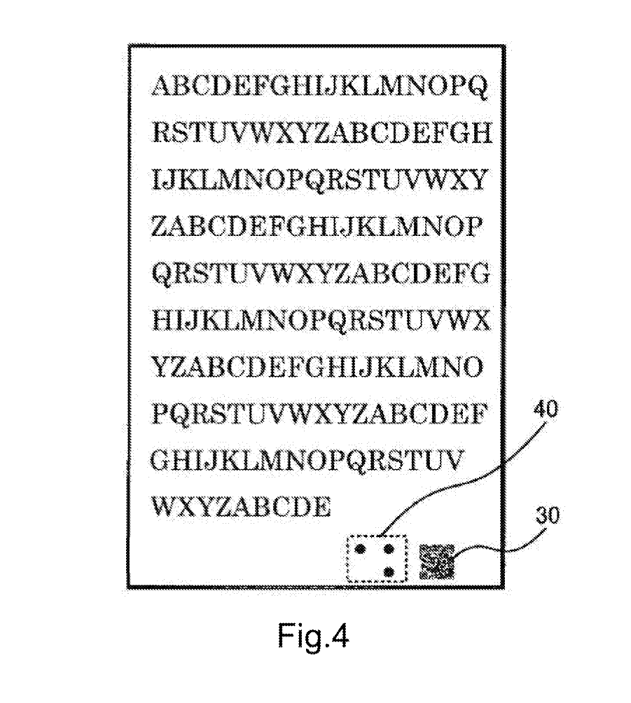

The symbol formation processing unit 104 controls a symbol forming operation by the symbol formation unit 17 according to the control program. Specifically, the symbol formation unit 17 forms a concave or convex symbol on a sheet forming the image thereon by the image formation unit 16. The symbol formation processing unit 104 controls the symbol forming operation by the symbol formation unit 17 such that a symbol is formed near the image of the speech recognition code. The symbols are added to the sheets forming the images thereon by the image formation unit 16 by the symbol forming operation of the symbol formation unit 17. A specific example in which a speech recognition code and a symbol are added to a sheet forming an image thereon will be described below with reference to FIG. 4. FIG. 4 is an image diagram of a document image with a speech recognition code formed by the image formation apparatus 100. As illustrated in FIG. 4, an image of text data and an image 30 of a speech recognition code corresponding to the text data are formed in one page of sheet. In other words, the image of text data and the image 30 of a speech recognition code are formed in one page of sheet such that the image of text data is associated with the speech recognition code. Specifically, the image 30 of a speech recognition code corresponding to the image of text data is formed below the image of text data. Additionally, a symbol 40 is formed near the image 30 of a speech recognition code within one page of sheet. The symbol 40 is braille, for example. The symbol 40 indicates a relative position of the image 30 of a speech recognition code such that the speech recognition code can be recognized by finger touch of a visually impaired person.

The output processing unit 105 outputs the image data input into the image formation apparatus 100 via the scanner apparatus 18 to the speech recognition code generation unit 103 and the print layout reconstruction unit 106 as illustrated in FIG. 3. The output processing unit 105 controls the image information reading operation by the scanner apparatus 18 according to the control program. Specifically, the output processing unit 105 controls the image information reading operation by the scanner apparatus 18 such that the scanner apparatus 18 scans the sheets of a printed material including characters thereby to read image information and generates image data according to the read image information. Further, the output processing unit 105 extracts the characters included in the image data in units of read page of sheet. The output processing unit 105 converts the characters into text data. The output processing unit 105 has an OCR function of extracting characters included in the image data and converting the characters into text data, for example. The output processing unit 105 outputs the text data to the speech recognition code generation unit 102 together with the image data as illustrated in FIG. 3. Further, the output processing unit 105 outputs the image data generated by the scanner apparatus 18 to the print layout reconstruction unit 106 described later.

The print layout reconstruction unit 106 acquires the speech recognition codes from the speech recognition code generation unit 102 as illustrated in FIG. 3. The speech recognition codes acquired by the print layout reconstruction unit 106 are generated by the speech recognition code generation unit 102 based on the text data output by the output processing unit 105. Further, the print layout reconstruction unit 106 acquires the image data from the output processing unit 105 as illustrated in FIG. 3. The print layout reconstruction unit 106 associates the speech recognition codes from the speech recognition code generation unit 102 with the image data from the output processing unit 105 in units of page read by the scanner apparatus 18 thereby to reconstruct the layout of the read pages into a layout of the pages to be printed. Further, the print layout reconstruction unit 106 outputs the information on the reconstructed layout to the image formation processing unit as illustrated in FIG. 3. The layout information includes position information on the script images in one page of sheet, position information on the images of the speech recognition codes, and position information on the symbols. The layout information includes information on margin size in one page of sheet, information on character size included in the script images, and the like. The image formation processing unit 103 controls the image forming operation by the image formation unit 16 based on the layout information.

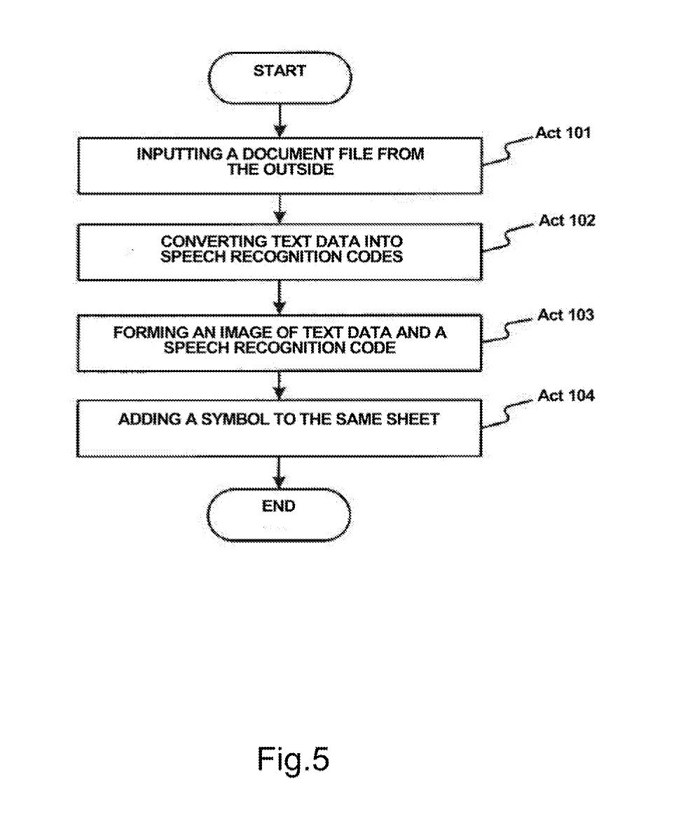

A specific example of the control processing by the control unit 11 for forming an image with a speech recognition code on a sheet based on a document file input from the outside such as the personal computer 200 will be described below with reference to FIG. 5. FIG. 5 is a flowchart illustrating a specific example of the control processing of forming an image with a speech recognition code on a sheet based on an externally input document file by the image formation apparatus 100. The user previously selects a function of converting text data into speech recognition codes and adding the speech recognition codes to the images to be printed on sheets. When the user selects the function and makes a print request, the image formation apparatus 100 performs the processing of forming an image with a speech recognition code on a sheet as illustrated in FIG. 5.

As illustrated in FIG. 5, in Act 101, the input processing unit 101 is input with a document file including text data from the personal computer 200 connected thereto via a network, an external memory (not illustrated) mounted on the image formation apparatus 100, or the like. The input processing unit 101 outputs the input document file to the speech recognition code generation unit 102.

The speech recognition code generation unit 102 generates speech recognition codes in Act 102. Specifically, the speech recognition code generation unit 102 acquires the document file from the input processing unit 101. The speech recognition code generation unit 102 converts the text data included in the document file into speech recognition codes in units of page. The speech recognition code generation unit 102 outputs the speech recognition codes to the image formation processing unit 103 together with the document file acquired from the input processing unit 101.

The image formation processing unit 103 controls the image formation unit 16 thereby to form the images in which the text data is associated with the speech recognition codes in units of page on sheets as described above in Act 103. After the images with speech recognition codes are formed on the sheets, the processing by the control unit 11 proceeds to Act 104. In Act 104, the symbol formation processing unit 104 controls the symbol formation unit 17. The symbol formation unit 17 adds a concave- or convex-formed symbol near the image of a speech recognition code in the sheet forming the text data and the image of the speech recognition code thereon. The image formation apparatus 100 adds the symbols to the sheets thereby to terminate the processing.

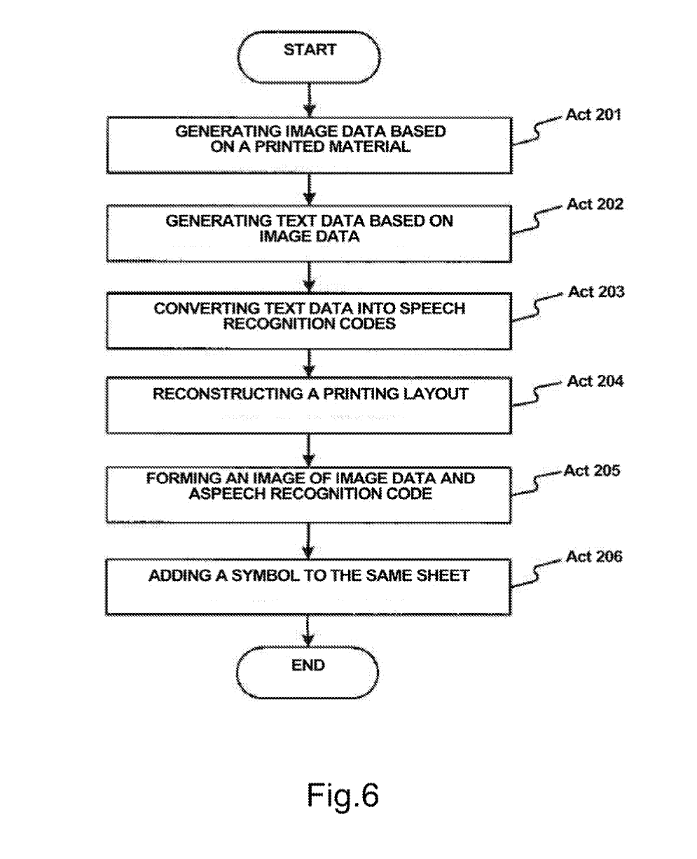

A specific example of the control processing by the control unit 11 for reading image information on a printed material by use of the scanner apparatus 18 and forming images with speech recognition codes on sheets will be described below with reference to FIG. 6. FIG. 6 is a flowchart illustrating a specific example of the control processing of forming an image with a speech recognition code by reading image information on a printed material by the image formation apparatus.

As illustrated in FIG. 6, the output processing unit 105 causes the scanner apparatus 18 to optically scan a printed material thereby to generate image data of the printed material in Act 201. In Act 202, the output processing unit 105 extracts the characters included in the image data generated by the scanner apparatus 18. The output processing unit 105 converts the characters into text data. The output processing unit 105 outputs the text data to the speech recognition code generation unit 102 together with the image data. Further, the output processing unit 105 outputs the image data to the print layout reconstruction unit 106. In Act 203, the speech recognition code generation unit 102 generates speech recognition codes based on the text data output by the output processing unit 105. Specifically, the speech recognition code generation unit 102 converts the text data into speech recognition codes. The speech recognition code generation unit 102 outputs the speech recognition codes to the print layout reconstruction unit 106.

In Act 204, the print layout reconstruction unit 106 acquires the speech recognition codes from the speech recognition code generation unit 102. Further, the print layout reconstruction unit 106 acquires the image data from the output processing unit 105. The print layout reconstruction unit 106 associates the speech recognition codes from the speech recognition code generation unit 102 with the image data from the output processing unit 105 in units of page read by the scanner apparatus 18, and reconstructs the layout of the read pages into a layout of the pages to be printed. Reconstructing a layout by the print layout reconstruction unit 106 will be described below in detail. The print layout reconstruction unit 106 outputs the reconstructed layout information to the image formation processing unit 103.

In Act 205, the image formation processing unit 103 acquires the image data and the speech recognition codes from the speech recognition code generation unit. Further, the image formation processing unit 103 acquires the layout information from the print layout reconstruction unit 106. The image formation processing unit 103 controls the image formation unit 16 thereby to form images in which the image data is associated with the speech recognition codes on sheets as described above based on the layout information. In Act 206, the symbol formation processing unit 104 controls the symbol formation unit 17. The symbol formation unit 17 adds a concave- or convex-formed symbol near the image of a speech recognition code in the sheet forming the text data and the image of the speech recognition code thereon. The image formation apparatus 100 adds the symbols to the sheets thereby to terminate the print processing.

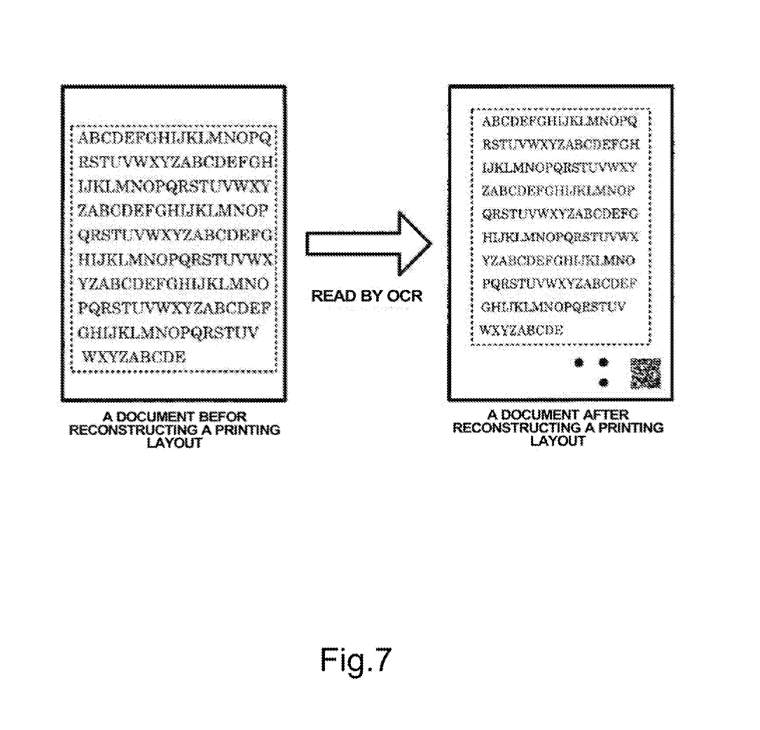

A specific example of image layout reconstruction when the image formation apparatus 100 forms an image with a speech recognition code on a sheet from an existing printed material will be described below with reference to FIG. 7. FIG. 7 is a diagram illustrating a specific example of an image whose layout is reconstructed by the image formation apparatus 100 when the image formation apparatus 100 forms an image with a speech recognition code on a sheet from an existing printed material. As illustrated on the left side of FIG. 7, only the script image is formed on one page of sheet in the layout of the image of the existing printed material read by the scanner apparatus 18. To the contrary, as described above, when the image data of the printed material is read by the OCR function of the output processing unit 105, the characters included in the image data are converted into text data. Further, speech recognition codes according to the text data are generated by the speech recognition code generation unit 102. The print layout reconstruction unit 106 associates the speech recognition codes from the speech recognition code generation unit 102 with the image data from the output processing unit 105 in units of page read by the scanner apparatus 18, and reconstructs the layout of the read pages into a layout of the pages to be printed. An image in which a speech recognition code is added to the image of the script is formed in one page of sheet based on the layout information as illustrated on the right side of FIG. 7. A symbol mark is further added near the image of the speech recognition code. Specifically, as illustrated on the right side of FIG. 7, the footer region is allocated in one page of sheet as a region in which an image of a speech recognition code and a symbol are formed. Further, a character size is reduced according to the allocated footer region as a region in which an image of a speech recognition code and a symbol are formed without changing an aspect ratio of the image of the characters included in the copy image of the script, the number of pages, and characters' line break positions. In other words, the layout of the image on the right side of FIG. 7 is an exemplary print layout reconstructed by changing the character size. Reconstructing a print layout is not limited to the example illustrated in FIG. 7. For example, the print layout may be reconstructed by changing the margin size without changing the character size.

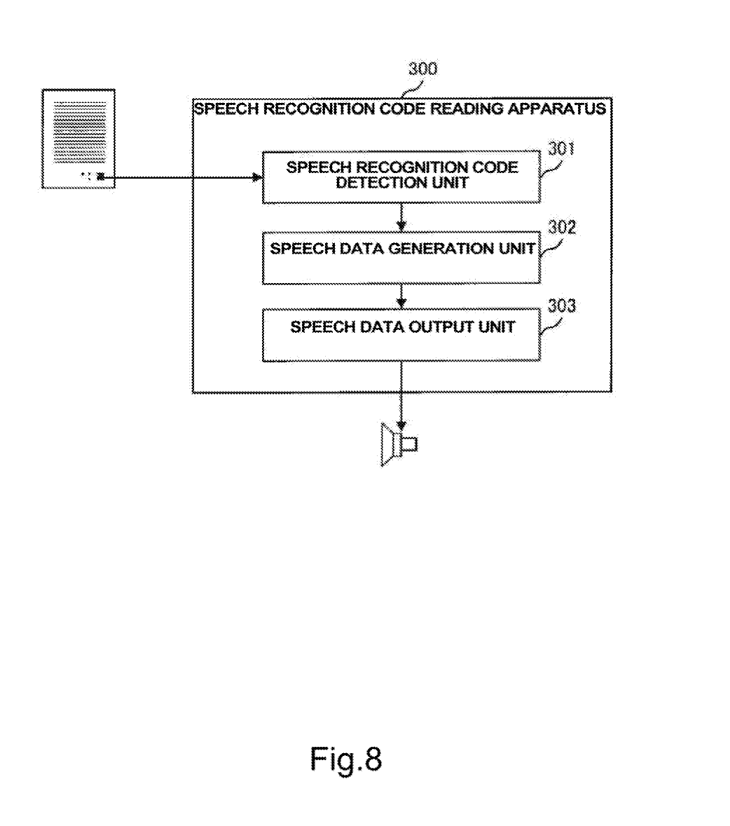

An exemplary apparatus capable of reading an image with a speech recognition code formed on a sheet by the image formation apparatus 100 will be described below with reference to FIG. 8. FIG. 8 is a diagram illustrating an exemplary structure of a speech recognition code reading apparatus capable of reading an image with a speech recognition code formed on a sheet by the image formation apparatus. As illustrated in FIG. 8, a speech recognition code reading apparatus 300 has a speech recognition code detection unit 301, a speech data generation unit 302, and a speech data output unit 303. The speech recognition code reading apparatus 300 may not be a dedicated device to the image formation apparatus 100. The speech recognition code reading apparatus 300 can be used by installing an application into a Smartphone or the like incorporating a camera therein, for example.

The speech recognition code detection unit 301 optically reads an image with a speech recognition code formed on a sheet by the image formation apparatus 100 as described above. The speech recognition code detection unit 301 optically reads the image thereby to detect the speech recognition code included in the image. The position where an image of the speech recognition code is formed in the sheet is not necessarily at the same position. However, a symbol is formed near the image of the speech recognition code in the sheet, and thus the user (visually impaired person) can determine the position of the image of the speech recognition code by touching. Thus, the user can easily read the speech recognition code by use of the speech recognition code reading apparatus 300 without depending on visual perception.

The speech data generation unit 302 converts (decodes) the speech recognition code detected by the speech recognition code detection unit 301 into text data. Further, the speech data generation unit 302 generates speech data from the text data. The speech data output unit 303 outputs speech via a speaker based on the speech data generated by the speech data generation unit 302.

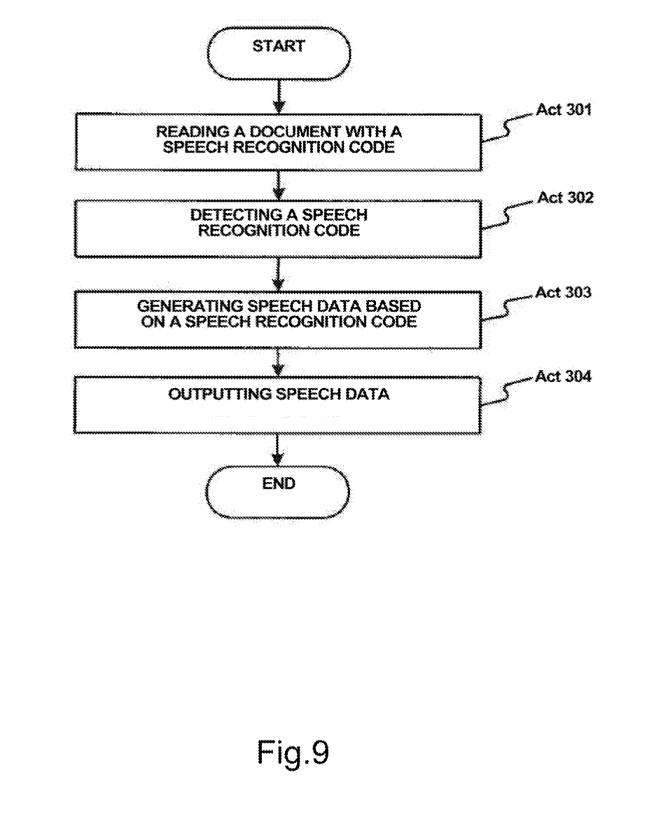

A specific example of the processing of generating speech data from an image with a speech recognition code by the speech recognition code reading apparatus 300 will be described below with reference to FIG. 9. FIG. 9 is a flowchart illustrating a specific example of the processing of generating speech data from a document with a speech recognition code by the speech recognition code reading apparatus 300.

As illustrated in FIG. 9, in Act 301, the speech recognition code detection unit 301 optically reads an image with a speech recognition code. In Act 302, the speech recognition code detection unit 301 detects the speech recognition code included in the image.

In Act 303, the speech data generation unit 302 converts the speech recognition code detected by the speech recognition code detection unit 301 into text data. Further, the speech data generation unit 302 generates speech data based on the text data. In Act 304, the speech data output unit 303 outputs speech via a speaker based on the speech data generated by the speech data generation unit 302. The speech recognition code reading apparatus 300 automatically reads the characters included in the image by outputting the speech. When completing the speech output, the speech recognition code reading apparatus 300 terminates the automatic reading processing.

As described above, with the image formation apparatus 100 according to the first embodiment, when a document file created by an external apparatus such as the personal computer 200 is printed, the user can select the function of converting text into speech recognition codes. Further, with the image formation apparatus 100, also when an existing printed material is read and printed, the user can select the function of converting text into speech recognition codes. When receiving the function selected by the user, the image formation apparatus 100 easily prints the images of the speech recognition codes together with the text on sheets at any timing. Thus, the user can give the speech recognition codes to any document file or existing printed material, thereby remarkably increasing the printed materials usable by the visually impaired persons.

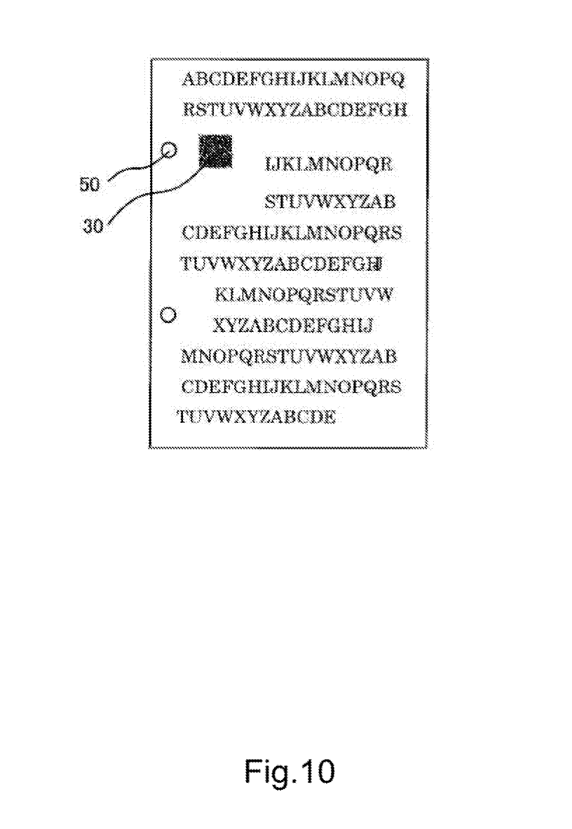

A variant in which the image formation apparatus 100 forms an image with a speech recognition code on a sheet will be described below with reference to FIG. 10. FIG. 10 is an image diagram of a sheet on which an image with a speech recognition code is formed by the image formation apparatus 100. As illustrated in FIG. 10, a punched hole 50 is formed near the image 30 of a speech recognition code on a sheet forming an image thereon and thus a concave symbol is formed. The image formation apparatus 100 is coupled with a conventionally-known sheet post-processing apparatus having a hole punching function as a symbol formation unit, thereby easily forming the punched hole 50 as a symbol.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image formation apparatus comprising:
an input processing unit configured to input a document file including text data;
a speech recognition code generation unit configured to generate speech recognition codes in units of page of the document file based on the text data included in the input document file; and
an image formation processing unit configured to control an image formation processing of forming images in which the document file including the text data is associated with the speech recognition codes in units of page on sheets.

2. The image formation apparatus according to claim 1, further comprising:
an output processing unit configured to optically scan sheets forming images including characters thereon thereby to read image information, generate image data according to the image information, convert the characters included in the image data into text data in units of read page, and output the image data and the text data.

3. The image formation apparatus according to claim 2,
wherein when optically scanning sheets forming images including characters thereon thereby to read image information, the speech recognition code generation unit acquires the image data and the text data output by the output processing unit, generates speech recognition codes in units of read page based on the text data, and outputs the speech recognition codes together with the image data.

4. The image formation apparatus according to claim 3, further comprising:
a layout reconstruction unit configured to, when optically scanning sheets forming images including characters thereon thereby to read image information, acquire the image data output by the output processing unit and the speech recognition codes output by the speech recognition code generation unit, associate the speech recognition codes with the image data in units of read page, and output layout information for reconstructing the layout of the read pages into a layout for forming the images on sheets.

5. The image formation apparatus according to claim 4,
wherein when optically scanning sheets forming images including characters thereon thereby to read image information, the image formation processing unit acquires the image data and the speech recognition codes output by the speech recognition code generation unit, and acquires the layout information output from the layout reconstruction unit thereby to form images in which the image data is associated with the speech recognition codes on sheets based on the layout information.

6. The image formation apparatus according to claim 5,
wherein the image formation processing unit controls an image forming operation of forming an image including characters according to the document file input by the input processing unit, an image including characters according to the image data output by the output processing unit and an image of a speech recognition code output by the speech recognition code generation unit based on the text data of the characters on one sheet.

7. The image formation apparatus according to claim 6,
wherein the image formation processing unit controls an image forming operation of forming an image of a speech recognition code near an image including characters.

8. The image formation apparatus according to claim 6, further comprising:
a symbol formation processing unit configured to control a symbol forming operation of forming a concave or convex symbol near an image of the speech recognition code in a sheet forming the image including characters and the image of the speech recognition code thereon.

9. The image formation apparatus according to claim 8,
wherein the symbol formation processing unit controls a symbol forming operation of forming braille on sheets as the symbols.

10. The image formation apparatus according to claim 8,
wherein the symbol formation processing unit controls a symbol forming operation of forming punched holes on sheets as the symbols.
